(19) United States
(12) Patent Application Publication
(10) Pub. No.: US 2017/0039735 A1
(43) Pub. Date: Feb. 9, 2017

(54) COMPUTED TOMOGRAPHY SELF-CALIBRATION WITHOUT CALIBRATION TARGETS

(71) Applicant: GENERAL ELECTRIC COMPANY, Schenectady, NY (US)

(72) Inventors: Ali Can, Niskayuna, NY (US); Bruno Kristiaan Bernard De Man, Clifton Park, NY (US); Jed Douglas Pack, Glenville, NY (US); John Christopher Boot, Altanta, GA (US); Eri Haneda, Clifton Park, NY (US)

(21) Appl. No.: 14/820,293

(22) Filed: Aug. 6, 2015

(51) Int. Cl. G06T 11/00; G01N 23/04; G06T 7/00; G01T 7/00

(52) U.S. Cl. CPC G06T 11/003; G01T 7/005; G01N 23/046; G06T 7/0012; G06T 2207/10081; G06T 2207/30004; G06T 2210/41; G06T 2211/421

(57) ABSTRACT

Approaches related to performing calibration of a CT scanner or of processes (e.g., correction and/or reconstruction) performed on acquired CT scan data are described. In certain described approaches, calibration is attained without performing a calibration scan using a dedicated calibration phantom. In certain embodiments, calibration is performed using a feature intrinsic to the imaged object, such as a jacket disposed about a drilled core sample.

### BACKGROUND

Non-invasive imaging technologies allow images of the internal structures or features of an object to be obtained without damaging or opening the object being investigated. In particular, such non-invasive imaging technologies rely on various physical principles, such as transmission of X-rays through the target volume or reflection of acoustic waves, to acquire data and to construct images or otherwise represent the internal structures or features that would otherwise be hidden.

For example, in X-ray based imaging technologies, X-ray radiation passes through an object of interest and a portion of the radiation impacts a detector where the image data is collected. In digital X-ray systems a photodetector produces signals representative of the amount or intensity of radiation impacting discrete pixel regions of a detector surface. The signals may then be processed to generate an image that may be displayed for review. In the images produced by such systems, it may be possible to identify and examine the otherwise hidden structures or features within an imaged object. In CT systems a detector array, including a series of detector elements, produces similar signals through various positions as a gantry is displaced around the object, allowing three-dimensional reconstructions to be generated.

In practice, such imaging systems must be calibrated on a regular basis to optimize system parameters for a given imaging context and to produce quality images. Further, the calibration values can change over time, making it difficult to keep an imaging system properly calibrated absent frequent calibration time that may actually reduce the time available for productive imaging operations. By way of example, the energy spectrum produced by an X-ray tube changes over time (i.e., as it ages) or as the temperature of the tube changes during prolonged use.

### BRIEF DESCRIPTION

In one embodiment, a processor-implemented method for calibrating a computed tomography (CT) imaging system is provided. In accordance with this method, a CT scan is performed on a cylindrical jacket and a core sample. The cylindrical jacket surrounds the core sample. A CT image of the cylindrical jacket and core sample is reconstructed using data acquired during the CT scan. A portion of the CT image corresponding to the cylindrical jacket is identified. One or more image quality metrics are derived based on the portion of the CT image. Based on the one or more image quality metrics, it is determined if one or more acquisition parameters, correction parameters, or reconstruction parameters are calibrated. If the one or more acquisition parameters, correction parameters, or reconstruction parameters are not calibrated, the one or more acquisition parameters, correction parameters, or reconstruction parameters are adjusted based on the one or more image quality metrics.

In an additional embodiment, an image processing system is provided. In accordance with this embodiment, the image processing system comprises a memory storing one or more routines, and a processing component configured to access previously or concurrently acquired computed tomography (CT) projection data and to execute the one or more routines stored in the memory. The one or more routines, when executed by the processing component: access CT projection data acquired of a cylindrical jacket surrounding a core sample; reconstruct a CT image of the cylindrical jacket and core sample using the CT projection data; identify a portion of the CT image corresponding to the cylindrical jacket; derive one or more image quality metrics based on the portion of the CT image; determine, based on the one or more image quality metrics, if one or more acquisition parameters, correction parameters, or reconstruction parameters are calibrated; and adjust, if the one or more acquisition parameters, correction parameters, or reconstruction parameters are not calibrated, the one or more acquisition parameters, correction parameters, or reconstruction parameters based on the one or more image quality metrics.

In a further embodiment, a non-transitory, computer-readable medium is provided storing one or more instructions executable by a processor. The instructions, when executed, perform acts comprising: reconstructing a CT image of a cylindrical jacket and core sample using data acquired during a CT scan, wherein the cylindrical jacket surrounds the core sample; identifying a portion of the CT image corresponding to the cylindrical jacket; deriving one or more image quality metrics based on the portion of the CT image; based on the one or more image quality metrics, determining if one or more acquisition parameters, correction parameters, or reconstruction parameters are calibrated; and, if the one or more acquisition parameters, correction parameters, or reconstruction parameters are not calibrated, adjusting the one or more acquisition parameters, correction parameters, or reconstruction parameters based on the one or more image quality metrics.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an embodiment of a computed tomography (CT) system configured to acquire CT images of a drilled core sample in accordance with aspects of the present discussion;

FIG. 2 depicts an embodiment of a generalized process flow for a calibration process performed using a feature of an imaged object, in accordance with aspects of the present discussion;

FIG. 3 depicts an embodiment of a process flow for a calibration process performed using a jacket of a drilled core sample as a calibration reference, in accordance with aspects of the present discussion;

FIG. 4 depicts a reconstructed image of a core sample and jacket, in accordance with aspects of the present discussion;

FIG. 5 depicts a reconstructed image of a jacket, in accordance with aspects of the present discussion;

FIG. 6 depicts a reconstructed image of a core sample, in accordance with aspects of the present discussion;

FIG. 7 an observed radial intensity profile for an image of a core sample and jacket, in accordance with aspects of the present discussion; and

FIG. 8 depicts a CT value profile of a metal jacket, in accordance with aspects of the present discussion.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure

While the following discussion is generally provided in the context of imaging drilled core samples, it should be appreciated that the present techniques are not limited to such contexts. Indeed, the provision of examples and explanations in such a drilled core imaging context is only to facilitate explanation by providing instances of real-world implementations and applications. However, the present approaches may also be utilized in other contexts, such as the non-destructive inspection of manufactured parts or goods (i.e., quality control or quality review applications) and/or the non-invasive inspection of packages, boxes, luggage, and so forth (i.e., security or screening applications) in which comparable structures suitable for use in a calibration operation may be present, identified, and utilized in a scan process.

The present discussion relates to the determination and/or optimization of one or more of: a mode of operation (e.g., operating parameters); reconstruction parameters; and/or correction parameters (e.g., beam hardening correction parameters) in a computed tomography (CT) context. In certain described embodiments, the imaged object includes or is proximate a structure or feature (e.g., an internal or external structure) that is suitable for use in a calibration operation. By way of example, in one embodiment, the imaged object is a drilled core sample, such as may be obtained in geological surveys or studies, which includes a metal jacket positioned around the circumference of a cylindrical core sample. In such an embodiment, the metal jacket, which is typically of known construction (e.g., known composition, dimensions, and so forth) is utilized as a calibration target during the scan process. In certain implementations, the jacket may be used in an initial calibration step. Further, in certain embodiments, use of the jacket as a calibration reference allows continuous or active calibration (e.g., tuning), thereby addressing changes that may occur over time, such as changing spectral characteristics of an X-ray tube as it ages and/or when the temperature fluctuates due to heavy or extended use.

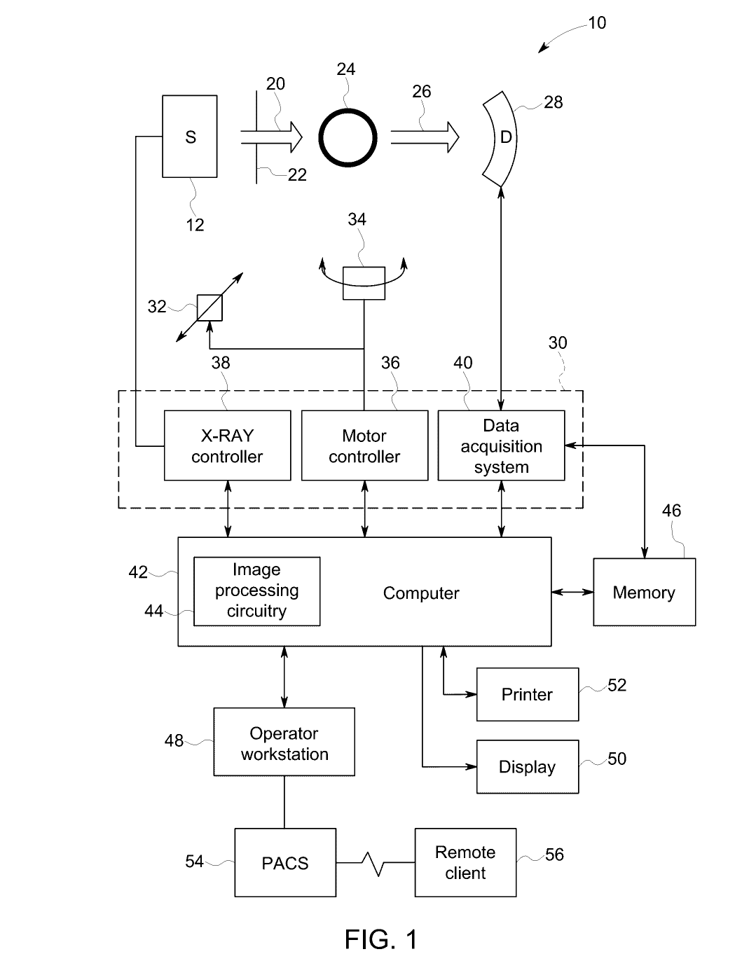

With the foregoing discussion in mind, FIG. 1 illustrates an embodiment of an imaging system 10 for acquiring and processing image data in accordance with aspects of the present disclosure. In the illustrated embodiment, system 10 is a computed tomography (CT) system designed to acquire X-ray projection data, to reconstruct the projection data into a tomographic image, and to process the image data for display and analysis. The CT imaging system 10 includes an X-ray source 12. As discussed in detail herein, the source 12 may include one or more X-ray sources, such as an X-ray tube or solid state emission structures. The X-ray source 12, in accordance with certain contemplated embodiments, is configured to emit an X-ray beam 20 from one or more emission spots (e.g., focal spots), which may correspond to X-ray emission regions on a target structure (e.g., an anode structure) impacted by a directed electron beam. In certain implementations, the source 12 may be positioned proximate to a collimator assembly 22 that may be used to shape and/or direct the emitted X-ray beam 20.

The emitted X-ray beam 20 passes into a region in which the object 24 undergoing imaging is positioned. The object 24 attenuates at least a portion of the X-rays 20, resulting in attenuated X-rays 26 that impact a detector array 28 formed by a plurality of detector elements (e.g., pixels). Each detector element produces an electrical signal that represents the intensity of the X-ray beam incident at the position of the detector element when the beam strikes the detector 28. Electrical signals are acquired and processed to generate one or more scan datasets.

A system controller 30 commands operation of the imaging system 10 to execute filtration, examination, correction, and/or calibration protocols and to process the acquired data. The detector 28 is coupled to the system controller 30, which commands acquisition of the signals generated by the detector 28. In addition, the system controller 30, via a motor controller 36, may control operation of a linear positioning subsystem 32 and/or a rotational subsystem 34 used to move components of the imaging system 10 and/or the object 24. The system controller 30 may include signal processing circuitry and associated memory circuitry. In such embodiments, the memory circuitry may store programs, routines, and/or encoded algorithms executed by the system controller 30 to operate the imaging system 10 and to process the data acquired by the detector 28 in accordance with the steps and processes discussed herein. In one embodiment, the system controller 30 may be implemented as all or part of a processor-based system such as a general purpose or application-specific computer system.

The source 12 may be controlled by an X-ray controller 38 contained within the system controller 30. The X-ray controller 38 may be configured to provide power, timing signals, and/or focal spot locations to the source 12. In addition, in some embodiments the X-ray controller 38 may be configured to selectively activate the source 12 such that tubes or emitters at different locations within the system 10 may be operated in synchrony with one another or independent of one another.

The system controller 30 may include a data acquisition system (DAS) 40. The DAS 40 receives data collected by readout electronics of the detector 28, such as sampled analog signals from the detector 28. The DAS 40 may then convert the data to digital signals for subsequent processing by a processor-based system, such as a computer 42. In other embodiments, the detector 28 may convert the sampled analog signals to digital signals prior to transmission to the data acquisition system 40. The computer 42 may include or communicate with one or more non-transitory memory devices 46 that can store data processed by the computer 42, data to be processed by the computer 42, or instructions to be executed by a processor 44 of the computer 42. For example, a processor of the computer 42 may execute one or more sets of instructions (such as for implementing a calibration routine or update as discussed herein) stored on the memory 46, which may be a memory of the computer 42, a memory of the processor, firmware, or a similar instantiation.

The computer 42 may also be adapted to control features enabled by the system controller 30 (i.e., scanning operations and data acquisition), such as in response to commands and scanning parameters provided by an operator via an operator workstation 48. The system 10 may also include a display 50 coupled to the operator workstation 48 that allows the operator to view relevant system data, imaging parameters, raw imaging data, reconstructed data, maps produced in accordance with the present disclosure, and so forth. Additionally, the system 10 may include a printer 52 coupled to the operator workstation 48 and configured to print any desired measurement results. The display 50 and the printer 52 may also be connected to the computer 42 directly or via the operator workstation 48. Further, the operator workstation 48 may include or be coupled to a picture archiving and communications system (PACS) 54. PACS 54 may be coupled to a remote system 56, such as over an internal or external network, so that others at different locations can gain access to the image data.

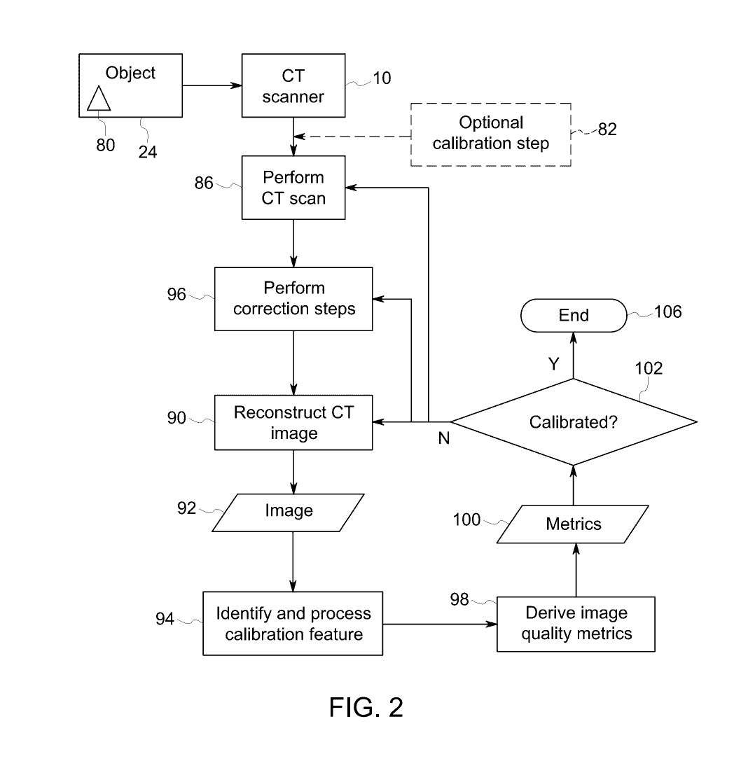

With the preceding in mind, the system of FIG. 1 may be operated so as to be initially calibrated, or periodically recalibrated, using features present within, about, or otherwise proximate to the object 24. For example, turning to FIG. 2, in the context of an object inspection (such as for quality control, fracture analysis, and so forth), the object 24 to be imaged may include an internal feature or part 80 of known composition, size, geometry, placement, and so forth that may be conventionally found in or on the object 24. In the depicted example, the object 24 is scanned (block 86) using a CT scanner 10. As will be appreciated, the scan operation 86 may be characterized by a number of parameters that may specify operational values related to X-ray generation (e.g., spectral characteristics and energy, emission interval and/or duration, and so forth), X-ray filtration or collimation, detector readout, relative motion of the CT scanner and object 24 (e.g., gantry speed), and so forth.

In certain embodiments, prior to the initial scan 86 of the object 24, a separate calibration scan (block 82) may optionally be performed (block 82). Such a calibration may be performed on a calibration phantom or other dedicated device designed for calibration purposes and may be employed to calibrate for beam hardening and/or to measure image quality. In such an embodiment, subsequent steps described herein may be for the purpose of recalibrating or reoptimizing the initial calibration without performing a separate calibration scan and/or by using features intrinsic to the imaging of the object 24, as opposed to a calibration phantom. Alternatively, if the initial calibration step 82 is not performed, all calibration and recalibration of the CT scanner 10 may be based on imaging operations performed on the object 24 having known feature 80.

With this in mind, once the object 10 is imaged, the data read out from the detector 28 may be reconstructed (block 90) to generate an image 92, which depicts the objet 24 and internal structures of the object 24, including feature 80 which may be in, on, or near the object 24. In certain embodiments, one or more correction steps may be performed (block 96) before and/or after the reconstruction of the image 92. Examples of such correction steps include, but are not limited to, beam hardening correction, scatter correction, and so forth. In practice, such correction steps may be performed in one or both of projection space (i.e., on the projection data prior to reconstruction) or in image space (i.e., on the reconstructed image), though to simplify discussion, a single correction step 96 is depicted in FIG. 2.

The image 92, after reconstruction and any post-reconstruction correction, is analyzed, such as using one or more automated identification and/or segmentation routines, to identify (block 94) the feature 80 within the image 92. Once identified, the image of the feature 80 may be processed to derive (block 98) one or more image quality metrics 100 that may be used to assess the calibration of the scanner 10, including data acquisition, correction, and/or reconstruction processing. Examples, of such metrics include, but are not limited to beam hardening extent, point spread function (i.e., resolution), structured noise (artifacts), and so forth.

In practice, the image of the feature 80 used to derive the image quality metrics 100 at step 98 may be the combined image 92 featuring both the object 24 and the feature 80. Alternatively, in other implementations, the image of the feature 80 used to derive the image quality metrics 100 at step 98 may be an image of the feature 80 alone, such as may be generated by extracting or segregating the image of the feature 80 from the overall image 92.

Based on the image quality metrics 100, a determination 102 may be made as to the calibration state of the scanner 10, the correction step(s) 96, and/or the reconstruction step 90. If the metrics 100, when compared to the acceptable thresholds and/or to the calibrated values, are determined to be within tolerance levels, the imaging process is ended (block 106) and the current image 92 is the final image.

Alternatively, if the metrics 100 are not determined to be within tolerance levels, one or more parameters controlling the scan acquisition process at step 86, one or more correction processes at step 96, and/or the reconstruction process at step 90 may be adjusted. By way of example, parameters related to scan acquisition that may be adjusted include, but are not limited to acquisition energy (KVp), acquisition current (mA), source bowtie filtration, extent of averaging, and so forth. Similarly, parameters related to image or data correction and/or reconstruction that may be adjusted include, but are not limited to beam hardening correction parameters, reconstruction sampling size, reconstruction filter type, and so forth.

If scan acquisition parameters (e.g., acquisition energy, acquisition current, source filtration, and so forth) are adjusted, an additional CT scan may be performed (block 86) to acquire new data using the adjusted parameters. If the scan acquisition parameters are not adjusted, but correction and/or reconstruction parameters are adjusted, the existing acquired data may undergo further correction or a new reconstruction using the new correction and/or reconstruction parameters. As shown in FIG. 2, the process may be implemented in an iterative manner, such that acquisition, correction, and/or reconstruction may be repeated once re-parameterized and the resulting image 92 depicting feature 80 re-evaluated until such time as it is determined that the image quality metrics 100 are within the desired tolerances.

While the preceding recounts a generalized description of the present approach, the following example relates to a specific implementation and use. As will be appreciated, this example is provided merely to illustrate a real-world use and to provide a useful, practical illustration of an implementation of the present approach. As such, it should be understood that the present approach is not limited based on such an example, and that such an example is provided merely to facilitate explanation.

With this in mind, the following example relates to the use of the present approach in imaging a drilled core sample. Such a core sample may be obtained in using drilling equipment configured to drill a cylindrical, geological sample, which is encased within a metal jacket, such as an aluminum or steel jacket (or other suitable metal jacket) having a diameter of 4′, 5′, 6′, or another suitable diameter. The jacket may be sealed or unsealed and, in some instances it may be of interest to image the drilled core sample prior to removing it from the jacket material. For example, images may be obtained to determine properties (e.g., fractures, porosity, and so forth) of the sample that may be of interest.

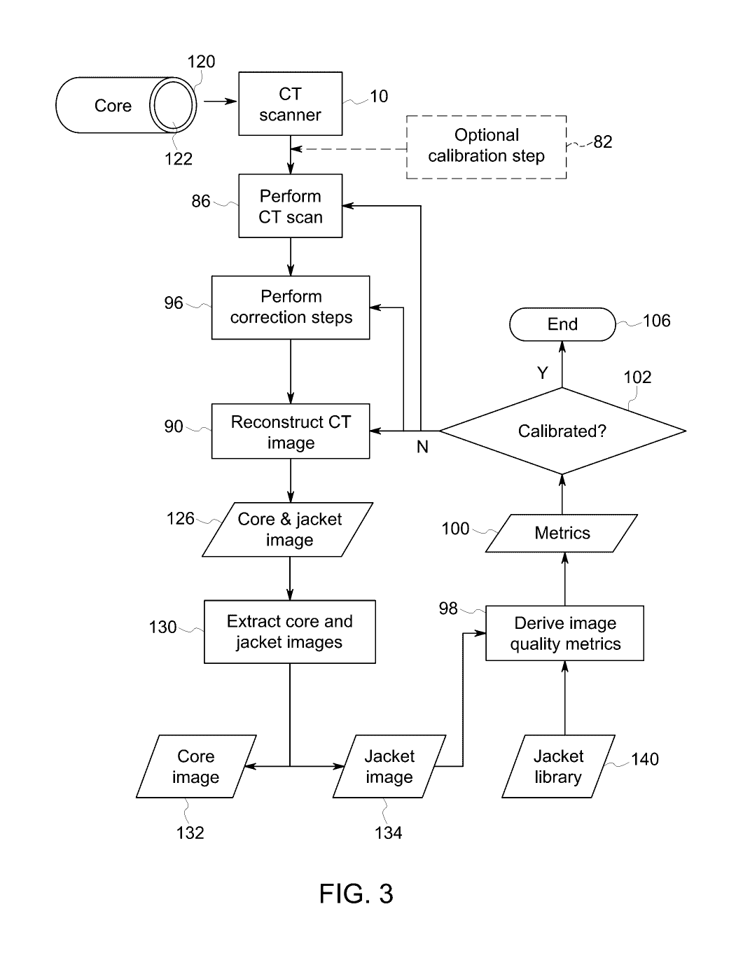

Turning to FIG. 3, an example of the present approach in the context of imaging a drilled core sample 120 contained within a metal jacket 122 is depicted. In this example, the core sample 120 within the jacket 122 is positioned within the CT scanner 10 and a CT scan is performed (block 86). As in the preceding example, the scan operation 86 (and calibration scan 82, if implemented) may be characterized by a number of parameters that may specify operational values related to X-ray generation (e.g., spectral characteristics and energy (including acquisition energy (KVp), acquisition current (mA)), emission interval and/or duration, and so forth), X-ray filtration or collimation (such as implementation of a bowtie filter), detector readout, relative motion of the CT scanner and object 24 (e.g., gantry speed), and so forth. Scan acquisition parameters may need to be recalibrated when there are major changes with respect to the acquisition system setup, such as when a different CT scanner is used, when jacket composition (e.g., switching from imaging aluminum to steel jacketed samples) is changed, and/or when the core sample size being imaged is significantly changed.

As in the preceding example, in certain implementations calibrations are performed using only the jacket 122 present around each core sample, thus eliminating the use of a separate calibration step 82 and the use of a special purpose calibration phantom. Alternatively, if an initial calibration step 82 is performed using a calibration phantom, subsequent imaging using the jacket 120 as a calibration reference may actively or continuously tune the initial calibration (e.g., to maintain calibration over time). Such tuning, regardless of whether an initial calibration 82 is performed or not, may be useful as, over extended use, the X-ray tube spectral characteristics may change, such as due to heating of the tube and its constituent materials.

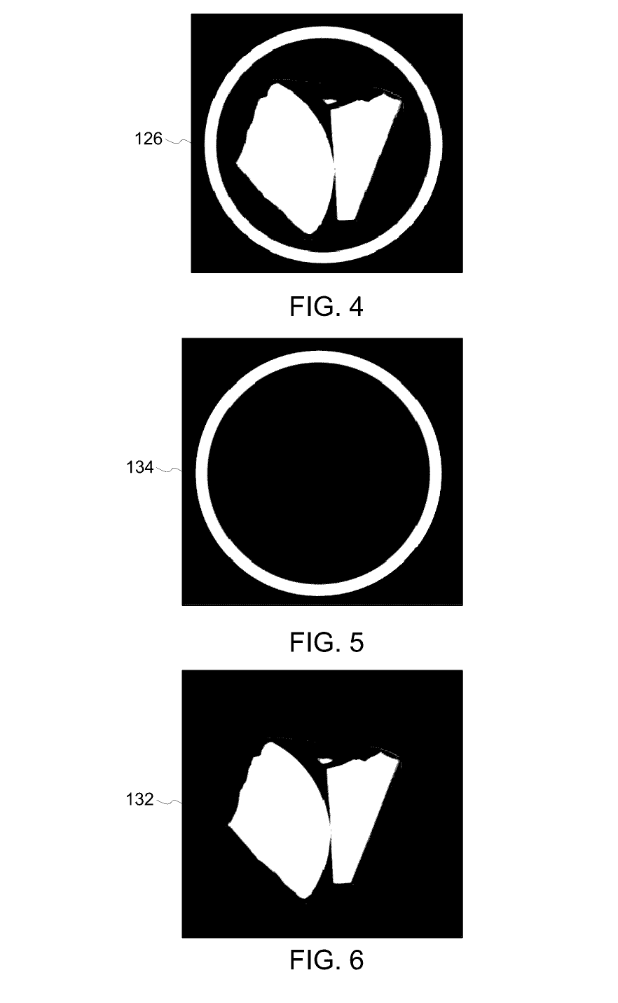

Turning back to FIG. 3, an image 126 of the core sample 120 and jacket 122 is reconstructed from the acquired scan data at step 90. An example of one such image is shown in FIG. 4. As discussed herein, one or more correction steps may be performed (block 96) before and/or after the reconstruction of the image 92. Examples of such correction steps include, but are not limited to, beam hardening correction, scatter correction, and so forth. Correction steps may be performed in one or both of projection space (i.e., on the projection data prior to reconstruction) or in image space (i.e., on the reconstructed image) though, as in the preceding example, a single correction “step” 96 is shown in FIG. 3 to simplify discussion.

In certain implementations, the image 126 is decomposed (block 130) to generate a separate core image 132 (see, for example, FIG. 6) and jacket image 134 (see, for example, FIG. 5). It should be appreciated, however, that in other implementations, subsequent operations may be performed on the combined core and jacket image 126, as opposed to being performed on one of the extracted images 132, 134.

In the depicted example, in which image decomposition is performed, the jacket image 134 may be segregated or extracted from the image 126, leaving a core image 132 as a corresponding product. In one embodiment, extraction of the jacket image 134 may be performed by a cylindrical fitting algorithm that estimates the position, orientation, and diameter of the jacket 120 within the image 126. In certain implementations, such a fitting operation may utilize a cylindrical model, i.e., a known geometry, which may be derived from a digital computer-aided design (CAD) model or drawing that corresponds to the respective jacket 120. In such an implementation, the known cylindrical model may be fitted to exterior points of the jacket 120 that are discernible in the combined jacket image 126 to determine the jacket geometry (i.e., position, orientation, center, diameter, and so forth). In such an embodiment, the fitting algorithm estimates these parameters in case the respective jacket 120 deviates from the manufactured specifications in some way (such as due to manufacturing defects) or in case the placement of the sample within the scanner 10 for image acquisition is flawed in some manner.

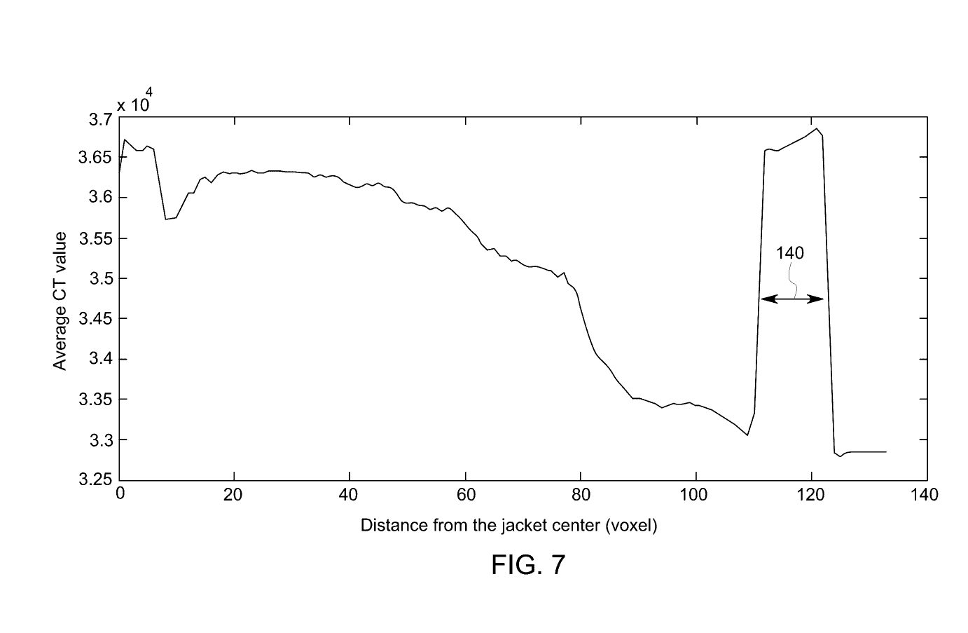

In one embodiment, a set of points for cylindrical fitting in this manner is determined by estimating noise levels outside the cylindrical jacket 120 and segmenting the air outside the jacket 120 to define a jacket boundary. The extracted cylinder boundary is then used to estimate the orientation, center, and diameter of the cylindrical jacket 120. The wall thickness of the jacket 120 can be specified manually by an operator, can be specified based on a known model or geometry of the jacket (such as based upon a CAD file), or may be determined from the radial distribution of intensities within the image 126 as a function of distance to the cylinder (i.e., jacket) center. By way of example, turning to FIG. 7, average CT values are shown plotted versus the distance from center of the jacket 120. In this example, the jacket wall, having a thickness 140, is readily apparent due to the sharp transition from low to high (and vice versa) CT values, which might be expected due to the metallic composition of the jacket wall. Thickness 140 of the wall may be determined as the distance between the rising and falling CT values at the wall location. Once the jacket wall thickness 140 is determined the combined image 126 may be decomposed into a core image 132 and a jacket image 134.

In the depicted example, the jacket image 134 (or corresponding jacket image region of image 126) is used to derive (block 98) one or more image quality metrics 100. Derivation of the image quality metrics 100 may be based, at least in part, on known properties (geometry, composition, size, and so forth) of the respective jacket 120, which may be obtained from a jacket library 140 (e.g., a database or datastore of attributes of various jackets 120) in certain embodiments. That is, the known material properties and geometry of the metal jacket 120 may be used to define (block 98) one or more image quality metrics 100.

Examples, of such metrics include, but are not limited to beam hardening extent, point spread function (i.e., resolution), structured noise (artifacts), and so forth. For instance, the extent of beam hardening present in the jacket image 134 (or combined image 126) may be a derived metric 100 and may be determined by measuring the deviation between maximum and minimum intensity on the average CT profile plotted as a function of distance from the center of the cylindrical jacket 120.

As discussed in the preceding example, based on the image quality metrics 100, a determination 102 may be made as to the calibration state of the scanner 10, the correction step(s) 96, and/or the reconstruction step 90. If the metrics 100, when compared to the acceptable thresholds and/or to the calibrated values, are determined to be within tolerance levels, the imaging process is ended (block 106) and the core image 132 (or core and jacket image 126) is the final image.

Alternatively, if the metrics 100 are not determined to be within tolerance levels, one or more parameters controlling the scan acquisition process at step 86, one or more correction processes at step 96, and/or the reconstruction process at step 90 may be adjusted. By way of example, parameters related to scan acquisition that may be adjusted include, but are not limited to acquisition energy (KVp), acquisition current (mA), source bowtie filtration, extent of averaging, and so forth. Similarly, parameters (e.g., coefficients) related to image or data correction and/or reconstruction that may be adjusted include, but are not limited to beam hardening correction parameters, reconstruction sampling size, reconstruction filter type, and so forth.

If scan acquisition parameters (e.g., acquisition energy, acquisition current, source filtration, and so forth) are adjusted, an additional CT scan may be performed (block 86) to acquire new data using the adjusted parameters. If the scan acquisition parameters are not adjusted, but correction and/or reconstruction parameters are adjusted, the existing acquired data may undergo further correction or a new reconstruction using the new correction and/or reconstruction parameters. As shown in FIG. 3, the process may be implemented in an iterative manner, such that acquisition, correction, and/or reconstruction may be repeated once re-parameterized and the resulting jacket image 134 (or core and jacket image 130) re-evaluated until such time as it is determined that the image quality metrics 100 are within the desired tolerances.

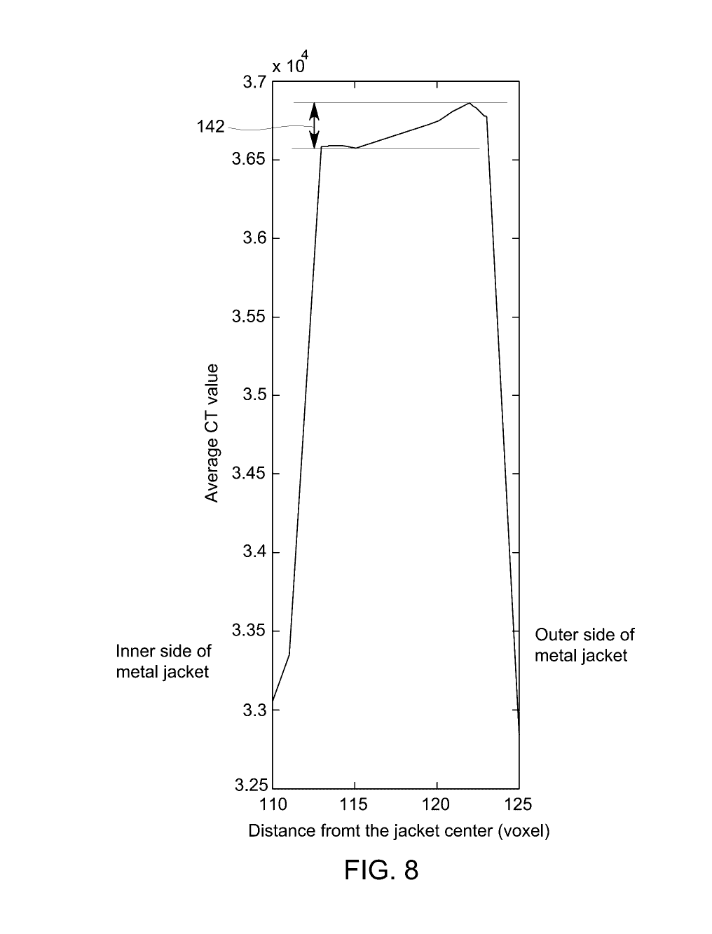

By way of further example, a derived beam hardening metric may be used as a cost function to optimize one or more correction parameters used at step(s) 96, such as one or more beam hardening correction parameters or coefficients. For instance, parameters for beam hardening can be estimated without a calibration step 82 by using the radial intensity distribution inside the jacket 120 as a cost metric. FIG. 8 shows radial intensity distribution for the jacket 120 shown in FIG. 5. Metrics that measure the extent of beam hardening can be defined using the radial intensity distribution, for example one metric can be defined as the ratio of the highest intensity to the lowest intensity inside the region corresponding to jacket 120, as indicated by height spread 142. Without beam hardening, this metric is expected to be close to 1. However due to beam hardening, the outer wall of the jacket appears brighter than the inner wall of the jacket, as shown by FIG. 8. Energy dependent beam hardening can be modeled using parametric models, either in a single energy or dual energy modality. For example in dual energy modality, only a small section of the jacket can be imaged with two energies to determine the unknown beam hardening parameters. The rest of the core can be imaged with only single energy. Coefficients of the parametric models may be adjusted in an iterative process to address the extent of beam hardening identified by the respective metric.

For instance, consider an implementation where:

[symbol]

_{corr}=c₁+c₂p²+c₃p³ (1)

where p is the measured sinogram values and [symbol] _{corr} is the beam hardening corrected sinogram. The image may be defined as

image=FBP( [symbol] _{corr}) (2)

where FBP is a filtered backprojection operation performed on the beam hardening corrected sinogram. With equations (1) and (2) in mind, an equation can be set forth:

y=c₁x₁+c₂x₂+c₃x₃ (3)

where y is the image to be reconstructed, x₁ is FBP( [symbol] ), x₂ is FBP( [symbol] ²), and x₃ is FBP( [symbol] ³). In this example, coefficients c₁, c₂, and c₃ are chosen so as to minimize the difference between image y and the desired image y^{desired} such that:

$${ }_{( {c}_{1} , {c}_{2} , {c}_{3} )}^{argmin} {‖ y - {y}^{desired} ‖}_{M}^{2} \qquad ( 4 )$$

provides the least squares normalization for mask M corresponding to a known region (e.g., the segmented jacket image).

In one such implementation, once beam hardening is corrected (i.e., once the cost function has been satisfied by iterative adjustment of the beam hardening correction factors and associated correction processing), the intensity distribution of the jacket 120 can be used to determine the structured noise (i.e., artifacts) and unstructured noise characteristics within the images. Further, the sharpness of the transition at the inner and outer wall of the jacket 120 in the images can be used to measure a point spread function (i.e., resolution). Based on these metrics, the scan parameters used at step 86, additional correction parameters used at step 96, and/or reconstruction parameters used at step 90 may be adjusted (e.g., optimized) to achieve the desired tradeoff between noise and resolution.

For example, a given reconstruction algorithm may have multiple modes of operation. Relevant reconstruction parameters for a given algorithm may set the reconstruction sampling size and/or may set the reconstruction filter type, either of which may have dramatic effects on the image quality. Based on measurements of the structured and unstructured noise inside the representation of the metal jacket 120 within the images, and based on the extent observed point spread function at the edges of the jacket 120, quantitative metrics may be derived to compare and optimize the modes of operation (e.g., sampling size, filter type, and/or other parameters) for the reconstruction algorithms.

With the preceding in mind, it may be appreciated that the ability to perform initial and/or subsequent calibrations using a feature intrinsic to the imaged object, such as a jacket disposed about a drilled core sample, allows parameters related to the acquisition, correction of, or reconstruction of scan data to be adjusted on a regular, if not continuous basis. This may help improve workflow and allow consistent image quality to be maintained.

Technical effects of the invention include calibrating an imaging system or function without use of a calibration phantom or, in some instances, a dedicated and separate calibration step. In some embodiments, a technical effect includes the use of a jacket disposed about a drilled core sample as a calibration reference to allow initial or subsequent calibration operations, such as to parameterize an acquisition operation, one or more correction operations, and/or a reconstruction operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A processor-implemented method for calibrating a computed tomography (CT) imaging system, comprising:
performing a CT scan on a cylindrical jacket and a core sample, wherein the cylindrical jacket surrounds the core sample;
reconstructing a CT image of the cylindrical jacket and core sample using data acquired during the CT scan;
identifying a portion of the CT image corresponding to the cylindrical jacket;
deriving one or more image quality metrics based on the portion of the CT image;
based on the one or more image quality metrics, determining if one or more acquisition parameters, correction parameters, or reconstruction parameters are calibrated; and
if the one or more acquisition parameters, correction parameters, or reconstruction parameters are not calibrated, adjusting the one or more acquisition parameters, correction parameters, or reconstruction parameters based on the one or more image quality metrics.

2. The processor-implemented method of claim 1, wherein no calibration scan is performed prior to performing the CT scan of the cylindrical jacket and the core sample.

3. The processor-implemented method of claim 1, further comprising performing one or more correction steps prior to or after reconstructing the CT image.

4. The processor-implemented method of claim 4, further comprising iterating at least the steps of reconstructing the CT image, performing one or more correction steps, deriving the one or more image quality metrics, and determining calibration status if one or more correction parameters or reconstruction parameters are adjusted.

5. The processor-implemented method of claim 1, further comprising iterating at least the steps of reconstructing the CT image, deriving the one or more image quality metrics, and determining calibration status if one or more acquisition parameters are adjusted.

6. The processor-implemented method of claim 1, further comprising decomposing the CT image into at least a jacket image comprising the portion of the CT image depicting the jacket, wherein the one or more image quality metrics are derived using the jacket image.

7. The processor-implemented method of claim 6, wherein decomposing the CT image into at least the jacket image comprises executing a cylindrical fitting algorithm that fits a cylindrical model to a portion of the CT image corresponding to the jacket.

8. The processor-implemented method of claim 1, wherein the one or more image quality metrics comprise one or more of a beam hardening extent metric, a point spread function metric, a structure noise metric, or an unstructured noise metric.

9. The processor-implemented method of claim 1, wherein the one or more acquisition parameters, correction parameters, or reconstruction parameters comprise one or more of an acquisition energy, an acquisition current, a source bowtie filtration, an extent of averaging, a beam hardening correction parameter, a reconstruction sampling size, or a reconstruction filler type.

10. An image processing system, comprising:
a memory storing one or more routines; and
a processing component configured to access previously or concurrently acquired computed tomography (CT) projection data and to execute the one or more routines stored in the memory, wherein the one or more routines, when executed by the processing component:
access CT projection data acquired of a cylindrical jacket surrounding a core sample;
reconstruct a CT image of the cylindrical jacket and core sample using the CT projection data;
identify a portion of the CT image corresponding to the cylindrical jacket;
derive one or more image quality metrics based on the portion of the CT image;
determine, based on the one or more image quality metrics, if one or more acquisition parameters, correction parameters, or reconstruction parameters are calibrated; and
adjust, if the one or more acquisition parameters, correction parameters, or reconstruction parameters are not calibrated, the one or more acquisition parameters, correction parameters, or reconstruction parameters based on the one or more image quality metrics.

11. The image-processing system of claim 10, wherein the one or more routines, when executed, perform one or more correction steps prior to or after reconstructing the CT image.

12. The image-processing system of claim 10, wherein the one or more routines, when executed, perform one or more correction steps, derive the one or more image quality metrics, and determine calibration status if one or more correction parameters or reconstruction parameters are adjusted.

13. The image-processing system of claim 10, wherein the one or more routines, when executed, iterate at least the steps of reconstructing the CT image, deriving the one or more image quality metrics, and determining calibration status if one or more acquisition parameters are adjusted

14. The image-processing system of claim 10, wherein the one or more image quality metrics comprise one or more of a beam hardening extent metric, a point spread function metric, a structure noise metric, or an unstructured noise metric.

15. The image-processing system of claim 10, wherein the one or more acquisition parameters, correction parameters, or reconstruction parameters comprise one or more of an acquisition energy, an acquisition current, a source bowtie filtration, an extent of averaging, a beam hardening correction parameter, a reconstruction sampling size, or a reconstruction filler type

16. The image-processing system of claim 10, wherein the one or more routines, when executed, decompose the CT image into at least a jacket image comprising the portion of the CT image depicting the jacket, wherein the one or more image quality metrics are derived using the jacket image.

17. A non-transitory, computer-readable medium storing one or more instructions executable by a processor, the instructions, when executed, performing acts comprising:
reconstructing a CT image of a cylindrical jacket and core sample using data acquired during a CT scan, wherein the cylindrical jacket surrounds the core sample;
identifying a portion of the CT image corresponding to the cylindrical jacket;
deriving one or more image quality metrics based on the portion of the CT image;
based on the one or more image quality metrics, determining if one or more acquisition parameters, correction parameters, or reconstruction parameters are calibrated; and
if the one or more acquisition parameters, correction parameters, or reconstruction parameters are not calibrated, adjusting the one or more acquisition parameters, correction parameters, or reconstruction parameters based on the one or more image quality metrics.

18. The non-transitory, computer-readable medium of claim 17, wherein identifying the portion of the CT image corresponding to the cylindrical jacket comprises executing a cylindrical fitting algorithm that fits a cylindrical model to a portion of the CT image corresponding to the jacket.

19. The non-transitory, computer-readable medium of claim 17, wherein the one or more acquisition parameters, correction parameters, or reconstruction parameters comprise one or more of an acquisition energy, an acquisition current, a source bowtie filtration, an extent of averaging, a beam hardening correction parameter, a reconstruction sampling size, or a reconstruction filler type.
